(19) United States
(12) Patent Application Publication
(10) Pub. No.: US 2007/0260510 A1
(43) Pub. Date: Nov. 8, 2007

(54) TRAVEL REWARD PROGRAM TARGETING AND OPTIMIZATION

(75) Inventors: Keith Chrzan, Chesterton, IN (US); Christopher James Gaia, St. Louis, MO (US); James M. Stone, Webster Groves, MO (US)

Correspondence Address: SENNIGER POWERS, ONE METROPOLITAN SQUARE, 16TH FLOOR, ST LOUIS, MO, 63102, US

(73) Assignee: Maritz Inc., Fenton, MO (US)

(21) Appl. No.: 11/381,638

(22) Filed: May 4, 2006

(51) Int. Cl. G06Q 30/00

(52) U.S. Cl. 705/14

(57) ABSTRACT

A method and system of developing a reward program to motivate participants associated with a program-owner. First and second different reward program are defined as a function of modeled values and defined attributes having values corresponding to collected preferred values. The program-owner compares the first reward program to the second reward program as a function of the weighted participants preferred values and selects and implements one of the reward programs based on the provided comparison.

### BACKGROUND

Domestic and international travel remains a popular and sought after experience for a majority of Americans. For those in charge of incentive travel reward programs, continuing to raise the bar each year while maintaining the desired effect of the program—motivating the workforce—is quite challenging. It is especially difficult for managers of reward programs with recurring top performers and large groups of 1000 or more, as there are only a small number of properties in the world that can provide top-notch experiences for groups of this size.

But, the travel reward challenge goes deeper than merely finding new locales and accommodations for large groups of earners who qualify each year. Workforces—particularly sales forces—are becoming increasingly diverse in terms of their cultural background, where they live, and their attitudes and expectations.

As the American workforce changes, reward program managers also must take into consideration the disparate ages, sexes, cultures, background, and thus, preferences of their employee base or channel partners. What motivates a 25-year-old African American female from New York can be quite different than what motivates a 50-year-old white male from Phoenix.

The growing number of satellite and virtual offices also poses a problem. Reward program managers must motivate people living and working throughout the US and abroad. Many are asking themselves questions similar to, “How do I motivate my Caribbean employees if my yearly reward trip is to the Caribbean?”

Finally, many reward program managers are under pressure to improve their sales numbers beyond what a group of top performers can deliver. The answer may lie in uncovering ways to motivate the so-called “middle performers,” while continuing to reward their best performers.

In the past, decisions regarding destination, length of trip and activities have been made on an ad hoc basis with little participant insight and understanding of how reward programs could be improved to provide the maximum motivation for the largest segment of participants.

### SUMMARY

Embodiments of the invention include a method of developing a reward program to motivate participants associated with a program-owner. In one embodiment, the invention includes a method of developing a reward program to motivate participants associated with a program-owner. The attributes and values of the reward program are defined and preferred values of the attributes are collected from the participants. The collected participant preferred values are modeled to generate weighted participants preferred values for the attributes of the reward program. First and second reward programs are defined as a function of the modeled values. The reward programs include some of the defined attributes having values and the values of the second reward program are different than the values of the first reward program. The reward programs are displayed to the program-owner with a comparison of the first reward program to the second reward program as a function of the weighted participants preferred values. The program-owner selects one of the displayed reward programs based on the provided comparison to implement and present to the participants.

In another embodiment, the invention includes a system for developing a reward program to motivate participants associated with a program-owner. The system includes one or more computer-readable media for storing a plurality of program attributes, the attributes defining the reward program and a collection of program choice information from the participants, the program choice information including participant preferred values of the attributes of the reward program. The system also includes a processor being configured to execute computer-executable instructions for displaying to the program-owner a first reward program and a second reward program, the first and second reward programs including the identified program attributes. The program attributes having values corresponding to the participant preferred values where the values of the first reward program are different than the values of the second reward program. Additionally, the processor being configured to execute computer-executable instructions for providing to the program-owner a comparison of the first reward program to the second reward program as a function of the collected program choice information.

In yet another embodiment, the invention includes a method of developing a reward program for a group of participants associated with a program-owner. A set of program attributes are defined, the programs attributes comprising the reward program. For each of the program attributes, a range of values is defined, the values being limited by the program-owner. The group of participants are surveyed, the survey designed to evaluate the group's preference to values of the program attributes. The responses to the survey are analyzed to define the reward program where the reward program includes the preferred value of the program attributes. The program-owner modifying the defined reward program as a function of the program-owner's constraints and goals. The modified reward program is presented to the group where the reward program is used to motivate the group.

In yet another embodiment, the invention includes a method of developing a reward program to motivate participants associated with a program-owner. Attributes of the reward program are defined, the attributes being associated with a corresponding variable and the variable includes a range of possible values for each attribute. Program choice information is collected from the participants, the program choice information including participant preferred variables of the attributes of the reward program. First reward program and a second reward programs are displayed to the program-owner, the first and second reward programs including of the identified program attributes and the program attributes having variables corresponding the participant preferred variables where the variables of the first reward program are different than the variables of the second reward program. The program-owner is provided a comparison of the first reward program to the second reward program as a function of the collected program choice information.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIGS. 1 and 3 are flow diagrams for a method of developing a reward program according to one embodiment of the invention.

FIG. 2. is a screen shot of a decision support tool according to one embodiment of the invention.

Corresponding reference characters indicate corresponding parts throughout the drawings.

### DETAILED DESCRIPTION

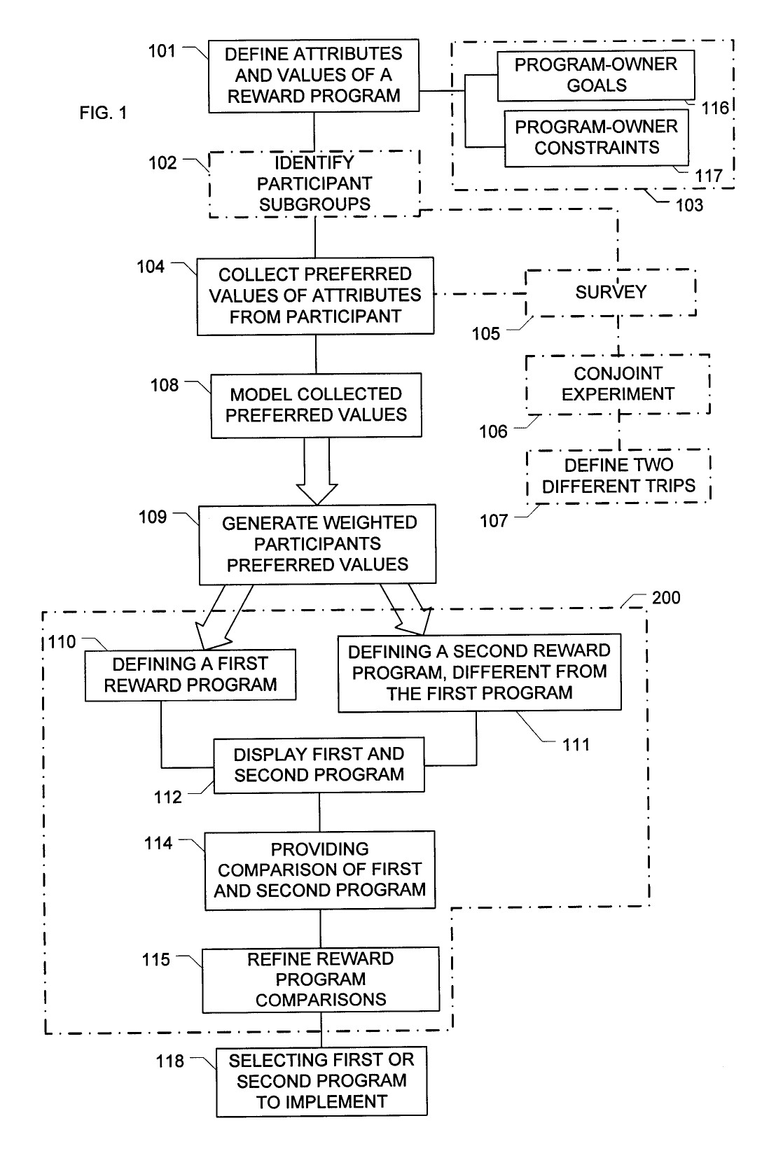

FIG. 1. is a flow diagram of one embodiment of a method for developing a reward program for participants related to a program owner. The program owner develops the reward program to motivate the participants by providing rewards when the participants attain an objective of the program owner. For example, a company (as a program owner) may wish to develop a reward program to motivate its salespeople (as participants) by providing merchandise (as the reward) for achieving and/or exceeding a sales objective. The program owner may include, but is not limited to one or more of the following: a company, consulting firm, an employer and a manufacturer. The participants may include, but are not limited to employees, salespersons, dealers and distributors related to the program owner. The reward program may include, but is not limited to at least one of the following as an incentive to motivate the participants: an award or other recognition, travel, a service (such as a spa visit), monetary award and merchandise.

FIG. 1 illustrates one embodiment of a method for developing the reward program which method may be accomplished by the program owner, by a third party, such as a program developer, on behalf of the program owner or by the owner working in conjunction with the developer. Once the reward program has been developed, a program manager (which may be the program owner or the program developer) implements the reward program. For example, the program manager administrators the reward program by enrolling participants, maintaining sales data, determining the winning participants, obtaining the reward for the participant, communicating with the participants the rules and eligibility for the reward program, and other related administrative functions. For convenience, it is assumed herein that the program manager is the program developer.

Referring to FIG. 1, the program owner initially identifies a list of program attributes for the reward program and a list of potential values for each of the attributes at 101. In one embodiment, program attributes may include, but are not limited to: Trip attributes, Attendee attributes, Activity attributes, Merchandise attributes and Program Guideline attributes. Trip attributes relate to the aspects of the travel award of the reward program. Trip attributes may include, but are not limited to: trip length, hotel type, destination type, destination choices, total trip attendees, number of trip types to choose from, choice of trip dates and air travel seating. Attendee attributes relate to groups who may attend the travel award of the reward program. Attendee attributes may include, but are not limited to: participant group type and type of attendees. Activity attributes relate to activities and events that are part of the reward program. Activity attributes may include, but are not limited to: big name entertainment, free time and opportunity to interact with senior management. Merchandise attributes relate to merchandise that is part the reward program. Merchandise attributes may include, but are not limited to: type of merchandise and merchandise grouping. And, Program Guideline attributes relate to the rules and regulations of the reward program. Program Guideline attributes may include, but are not limited to: opportunity to earn reward, length of reward program and ability to bank rewards.

Once the program attributes are defined, a list of potential values for each program attribute is specified. Potential values for the program attributes are the possible values for the program attribute. In one embodiment, for example, coach class air travel, coach class air travel with the opportunity to earn first class, and first class air travel may be identified as possible values for an air travel seating trip attribute.

Subgroups of participants are optionally identified at 102 by the program owner. By identifying subgroups of participants, the program owner is able to target the reward program to a particular group of participants. For example, if the program owner identifies the participants by geographic sales region, then the program owner can develop a reward program targeted to the participants within the particular geographic sales region. Subgroups of participants may be related to demographic data, firmographic data, and past reward travel experience data.

Demographic data may include, but are not limited to the following information regarding the participant: geographic location, age, gender, ethnicity, marital status, number of children, education and household income. Firmographic data may include, but are not limited to the following information regarding the participant's employment: job function, level of responsibility and years of service. And, past reward experience data may include, but are not limited to the following information regarding the participant's past experiences with reward programs: persons who earned a reward program in the past, the number of times a person has earned a reward program in the past and by the length of time since a person has last earned a reward program.

As part of defining the defining of the program attributes and the list of potential values for each of the attributes, the program attributes and values are modified per the program owner's goals 116 and constraints 117. The goals 116 are the objectives of the reward program. For example, if sales have been sluggish in the Midwest sales district, then the goal 116 would be to implement the reward program that specifically appeals to participants within the Midwest. In this example, the program owner would identify sales districts as a subgroup of participants.

The constraints 117 are program owner limitations to the reward program. For example, the cost of the reward program may be a constraint. In this case, the employer may wish to limit the trip destination to the United States and Mexico or limit the length of the travel award to a 3 or 4 day trip.

In one embodiment, an optional workbook 103 is provided to the program owner to aid the owner in identifying the program attributes and values, subgroups of participants, and possible group activities. Appendix A contains a sample workbook. The program owner evaluates and modifies the information provided in the workbook to suit his or her goals 116 and constraints 117.

At 104, the participant preferred values of the program attributes are collected by the program manager. In one embodiment, a survey 105 is provided to a subset of potential participants to collect participant preferred values. The survey 105 may be offered to all participants, all potential participants in the reward program, or a subset of the potential participants. The survey 105 may be conducted online, conducted through paper surveys, or conducted through any other known surveying techniques.

The participant preferred values are gathered at 104 through a choice-based conjoint experiment 106 in the survey 105 that measures the impact on motivation of attributes that make up the reward program through utility estimates. In the experiment 106, participants are asked questions that require them to choose among pairs of reward programs that always differ on a small number of program attributes values. If the program owner decides not to offer a particular value for one of program attributes, then that value will not be part of the experiment 106. For example, if the program owner decides that the reward program will not include first class air travel, than the first class air travel value for the air travel seating trip attribute will be eliminated from the experiment 106.

In one embodiment, participants are shown the survey 105 as including two different trips 107 side by side and are asked to choose the one they would work harder to earn during the survey 105 to collect the participant preferred values. For example, an employee taking the survey 105 looks at two trips, Trip A and Trip B. Trip A offers ten different destination choices at a large luxury hotel for a four-night stay. Employees can choose between four dates to travel and may bring a guest, but no children. Trip B offers only one destination, at a large luxury hotel with a five-night stay. This trip is offered on only one date and also allows participants to bring a guest, but no children. The employee must choose between Trip A and Trip B. Employees repeat this choice exercise several times with systematically different trip attributes and values to consider.

In another embodiment, as shown in FIG. 5, the participants are shown three different trips 107 and a merchandise package side by side and are asked to choose the one they would work harder to earn to collect the participant preferred values

The survey 105 includes enough questions per participant to allow the participant preferred values to be analyzed via hierarchical Bayesian multinomial logit (HB-MNL). Appendix B contains the survey questions used to create the choice-based conjoint experiment to collect participant preferred values in one embodiment of the invention. The questions include 3 versions of 18 questions each to reduce respondent burden; otherwise each respondent would have to answer all 54 questions or the total number of questions asked in the survey would have to be reduced. Each participant is randomly assigned one of the versions of 18 questions. The 18 questions are then presented to the participant in random order to counterbalance order effects.

In embodiments where subgroups of participants have been identified at 102, subgroup data is collected by asking the participants direct questions about demographics, firmographics, past program participation in the survey 105. The collected subgroup data allows participant preferred values for subgroups of participants to be identified. Appendix C contains questions used to create an online survey to collect the subgroup data in one embodiment of the invention. In other embodiments, the program owner may have access to data regarding participant subgroups such that it may not be necessary to survey the participants for all or a portion of the subgroup data.

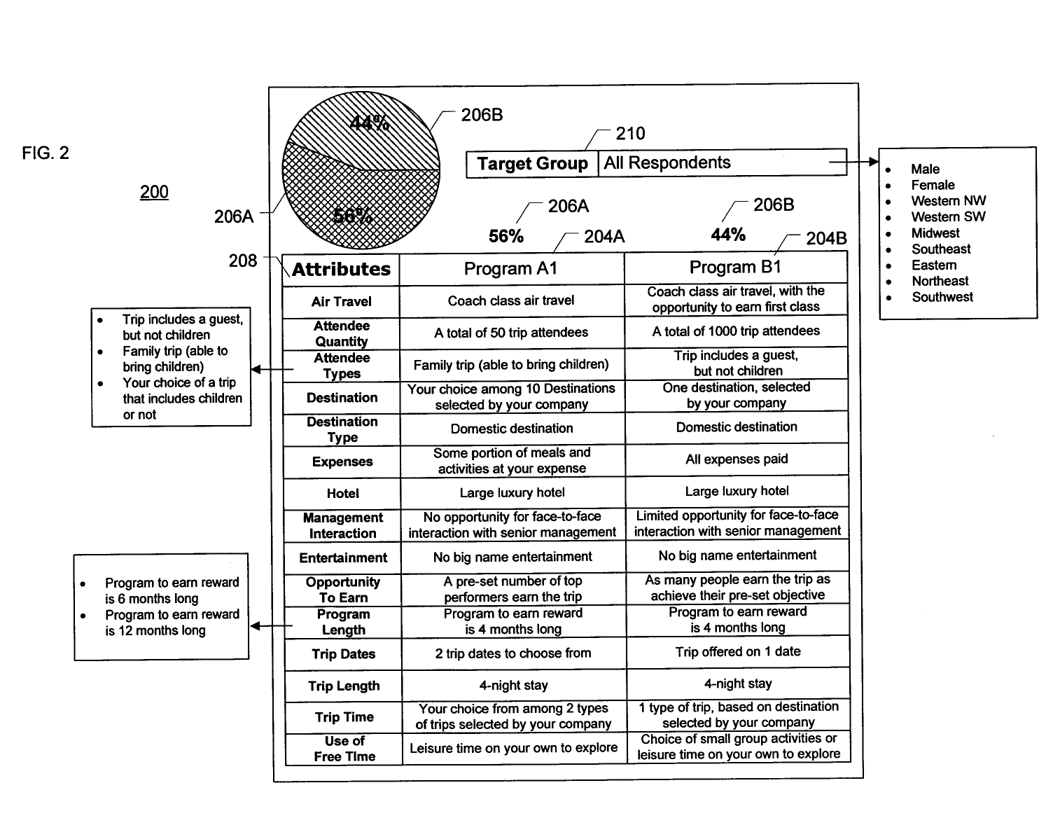

After the survey 105 is completed, at 108 the collected participant preferred values are analyzed via HB-MNL to generate a set of weighted participant preferred values 109. The weighted participant preferred values 109 quantify the participants' preference for a value of a program attribute. In one embodiment, the weighted participant preferred values 109 are used to build a user interface decision support tool 200, as shown in FIG. 2, to simulate the participants' preference to reward programs with different program attribute values. The HB-MNL analysis generates a statistical model that predicts each respondent's choices as a function of the attributes and levels in the experimental design (i.e. as shown in the versions of the survey). The tool 200 is used by the program owner to simulate the participant's preferences to potential reward programs. The decision support tool 200 is a conjoint simulation that may be implemented in a spreadsheet or other computer program. The HB-MNL analysis produces utilities which are the raw materials for the decision support tool 200.

In FIG. 1, at 110, a first reward program is defined. To define the first reward program, each of the program attributes identified at 101 are initialized to a default of value. The default value selected for each of the attributes is from the set of potential values identified at 101. In FIG. 2, program A1 204A is one example of a defined first reward program.

Referring again to FIG. 1, a second reward program is defined at 111. The second reward program also includes each of the program attributes identified at 101 and the value for attribute is selected from the set of potential values identified at 101. However, at least one of the values selected for one of the program attributes of the second program is different that the value of the program attribute selected for the first program. Program B1 204B shown in FIG. 2 is one example of a defined second reward program. As shown in FIG. 2, several of the program attributes including air travel, attendee quantity, and trip length have different values in program A1 204A and program B1 204.

In FIG. 1, at 112, the first and second programs are displayed to the program owner. In one embodiment, the program owner views the first and second reward programs in the decision support tool 200 shown in FIG. 2. In FIG. 1, at 114, the program owner is provided with a comparison of the first and second reward programs. The comparison communicates to the program owner how many of the participants are more motivated by the first reward program compared to the second reward program. The comparison is calculated as a function of the weighted participant preferred values 109. In one embodiment, as shown in FIG. 2, the comparison of the first 204A and second reward 204B programs is expressed as a percentage 206. For example, in the comparison shown FIG. 2, 56% 206A of the participants are more motivated by program A1 204A compared to 44% 206B of the participants who are more motivated by program B1 204B.

In one embodiment, a first choice rule is utilized for HB-MNL weighted participant preferred values 109 or utilities. The total participant preferred values 109 is calculated for each reward program 204 for each respondent by summing the participant preferred values 109 for each attribute of the reward program 204. Using the first choice rule, the simulation predicts that a given respondent would choose the reward program 204 with the higher total participant preferred values.

In another embodiment, a logit choice rule is utilized with aggregate participant preferred values 109 or utilities. Participant preferred values 109 are summed for a total for each reward program 204. A prediction of preference of the respondent is calculated as a percentage of the exponential function of each total utility.

At 115, the program owner is given the opportunity to refine the reward program comparisons by modifying the values of the program attributes and selecting subgroups of participants. This allows the program owner to compare various reward programs and select the reward program that will best motivate the participants of the reward program.

For example, if sales have been sluggish in the Midwest sales district, then the program owner would want to implement the reward program that specifically appeals to participants within the Midwest. In this example, the program owner may select a subset of participants who belong to the Midwest sales district and view the comparison of the first and second reward programs for the selected subset of participants. In this case, the comparison would communicate to the program owner how many of the Midwest participants would find the more motivating program between the first reward program compared to the second reward program.

The program owner can continue to modify program attributes to determine what type of a reward program will appeal to the participants. For example, the program owner may modify the second reward program's destination attribute to “International destination” while leaving the first reward program's destination attribute to “Domestic destination”. The comparison would communicate to the program owner how many of the participants are more motivated by the first reward program with a domestic destination compared to the second reward program with an international destination.

Referring again to FIG. 1, at 118 the program owner selects the reward program to implement. In one embodiment, the program owner selects the reward program that best motivates the participants. Once the reward program has been selected, the program manager implements the reward program and presents it to the participants.

The decision support tool 200 is a conjoint simulation that may be implemented in a spreadsheet or other computer program. The decision support tool 200 includes a user interface, such as the embodiment illustrated in FIG. 2. The decision support tool 200 is used by the program owner to simulate the preferences of participants to a variety of possible reward programs 204.

Through the decision support tool 200, the program owner is provided with a comparison of the first 204A and second 204B reward programs. The comparison communicates to the program owner how many of the participants are more motivated by the first reward program 204A compared to the second reward program 204B. The comparison is generated as a function of the weighted participant preferred values 109. In one embodiment, the comparison is shown as a percentage 206. For example, as shown in FIG. 2, 56% of all participants 210 are more motivated by the first reward program 204A compared to 44% of all participants 210 who are more motivated by the second reward program 204B.

The decision support tool 200 also allows the program owner to refine the reward program comparisons by modifying the values of the program attributes 208 and selecting subgroups of participants 210. This allows the program owner to compare various reward programs and select the reward program 204 that will best motivate the participants.

The program owner may select a new subgroup 210 from the subgroups that were identified during the survey 105. Subgroups 210 help the program owner to create reward programs that appeal specifically to subgroups of participants. Once the new subgroup 210 is selected, the decision support tool 200 will recalculate the comparison 206 for the selected subgroup 210.

The program owner may also modify program attributes 208 to determine what type of a reward program will appeal to the participants. For example, the program owner may modify the second reward program's hotel attribute to “Small boutique hotel” while leaving the first reward program's hotel attribute to “Large luxury hotel”. The comparison 206 would communicate to the program owner how many of the participants are more motivated by the first reward program 204A with a small boutique hotel compared to the second reward program 204B with a large luxury hotel. The program owner may continue to refine the reward program comparisons 206 by modifying the values of the program attributes 208 until he determines that one of reward programs 204 will best achieve the goals 116 within any constraints 117.

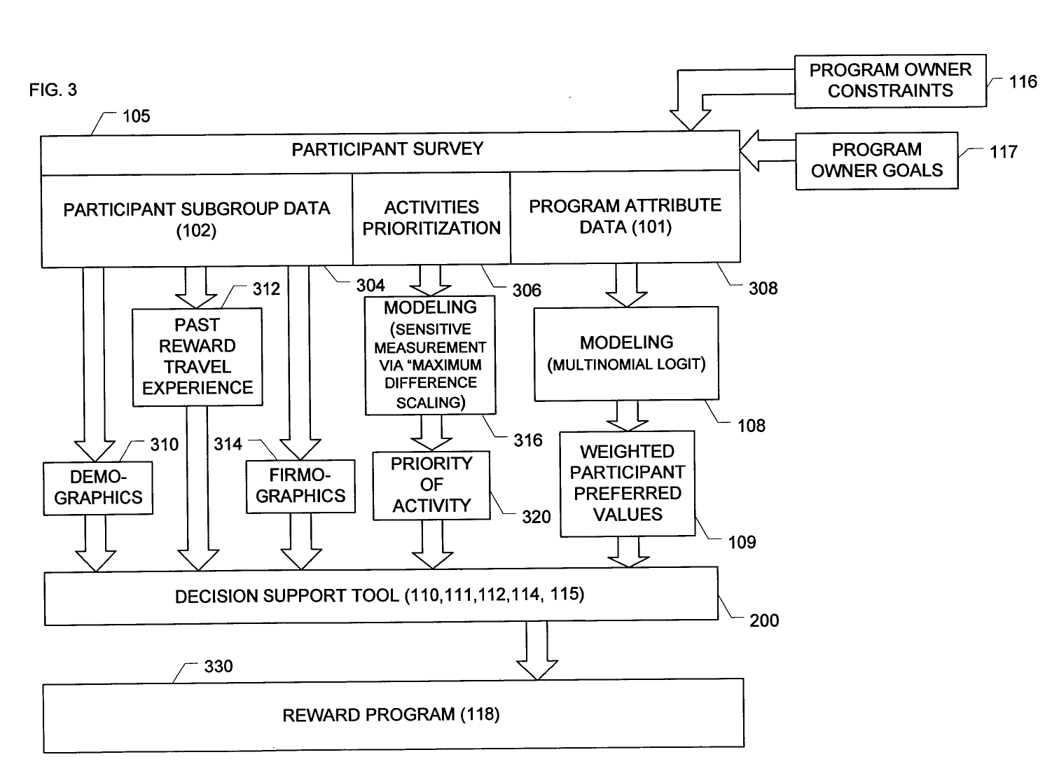

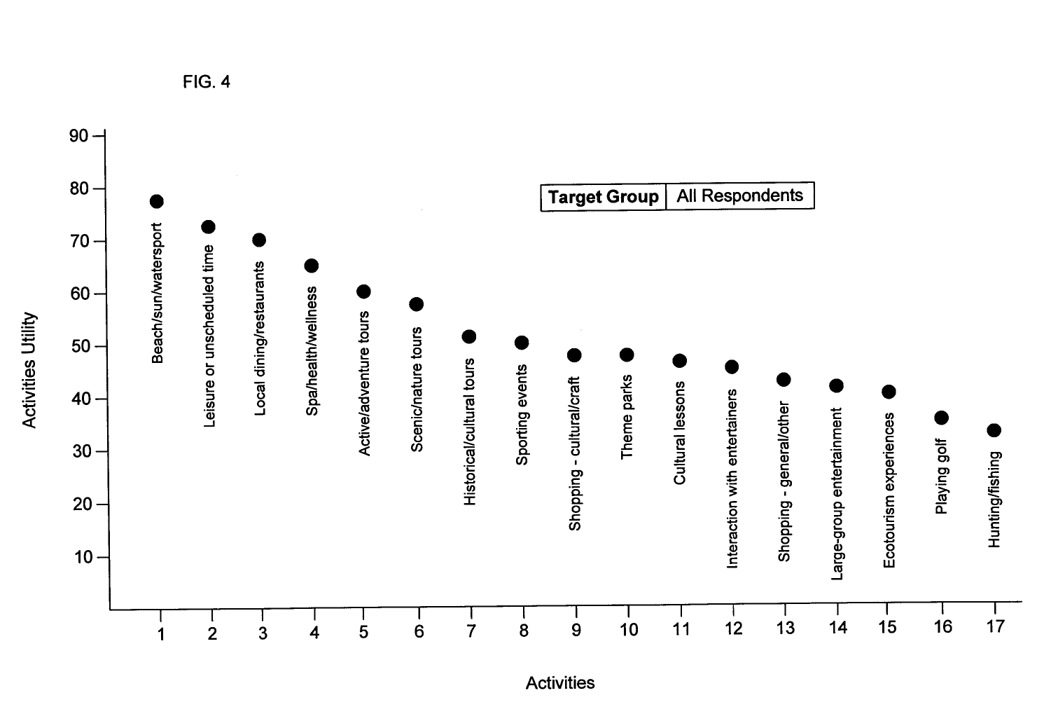

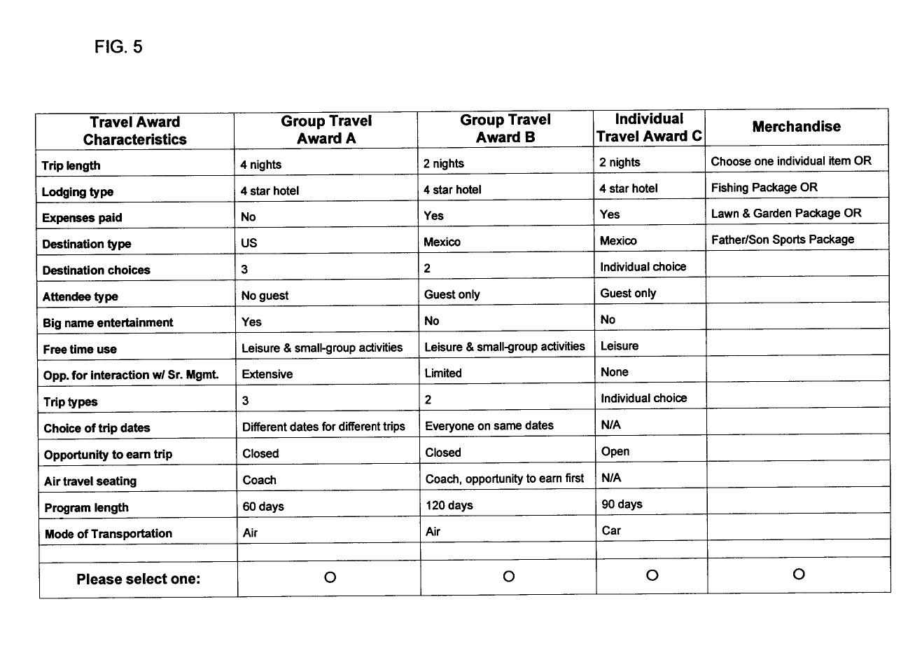

In FIG. 3, the survey 105 is conducted to collect participant subgroup data 304, activity prioritization data 306 and program attribute data 308 for building a decision support tool 200. In one embodiment, the participants receive an email invitation to participate in the survey 105. In another embodiment, to encourage the participants to complete the survey 105, participants are paid $5 and entered in a $1,000 drawing. In another embodiment, the survey 105 is conducted via an online questionnaire. Optionally, respondents may pause the online survey and complete it at a later time.

Participant subgroup data 304 includes direct questions about demographics, firmographics, past program participation that are utilized to identify subgroups of respondent. The subgroups are determined by the demographic data 310, firmographic data 314 and past reward travel experience data 312 collected through direct questions within the survey 105.

In one embodiment, the program owner identifies a list of potential activities that may be included in the reward program. Activity prioritization data 306 is gathered to provide the program owner with a ranking of participants' preferences to the each of the identified activities. In one embodiment, the ranking is displayed as a chart

Activity prioritization data 306 is gathered through a maximum scaling experiment 316. The experimental design used to gather the data may include, but are not limited to 2^{k} Factorial, Balanced Incomplete Block Designs (BIB), and Partially Balanced Incomplete Block Designs (PPIB). The maximum difference scaling experiment is designed to measure the utility of all activities 320 allowing enough observations per respondent for analysis via hierarchical Bayesian multinomial logit (HB-MNL). In one embodiment, 3 observations per respondent per activity were sufficient for analysis via (HB-MNL) and any more observations was a point of diminishing returns.

Appendix D contains an embodiment where each respondent is asked one of the 4 cells of activities questions in the survey 105. Each cell contains 37 questions. In cell 3, the respondent was asked the activity he would most like to do and the activity he would least like to do among the 4 activities in each of the questions. In cell 2, the respondent was asked the activity he would most like to do and the activity he would least like to do among the 5 activities in each of the questions. In cell 3, the respondent was asked the activity he would most like to do and the activity he would least like to do among the 6 activities in each of the questions. And in cell 4, the respondent was asked the activity he would most like to do and the activity he would least like to do among the 7 activities in each of the questions. By using 4 cells of questions, 4 times the possible measurement domain is covered compared to using only 1 cell of questions. With greater measurement domain coverage, the measurements are more accurate.

For example, while taking the survey 105, the respondent is asked to choose between the following four trip activities:
(2) local dining/restaurants
(3) cultural experiences (such as destination-specific cooking [i.e., Cajun, French], art/painting lessons, etc.);
(4) scenic/nature tours, and
(5) hunting/fishing
   The respondent must choose one activity she would like to do most and one she would like to do least. The respondent does this repeatedly with different subsets of activities. In one embodiment, activities may include, but are not limited to: scenic tours, nature tours, historical tours, cultural tours, golf, spa activities, health activities, wellness activities, beach activities, water sport activities, cultural shopping, general shopping, leisure time, sporting events, theme parks, cultural lessons, hunting, fishing, adventure tours, local dining, ecotourism, interaction with popular entertainers, interaction with popular celebrities, concerts, and entertainment award ceremonies.

An exemplary embodiment of a graphical user interface for accessing the activity utilities by subgroups is shown in FIG. 4. The graphical user interface may be part of the decision support tool 200. The graphical interface ranks the activities for a participant subgroup. In one embodiment, the HB-MNL analysis produces a utility for each activity for each respondent, and these utilities are accessed and totaled by the interface to generate the ranking of the activities for the participant's within the selected subgroup. This allows the program owner to define the reward program 330 that will include activities that appeal to one or more subgroups.

Program attribute data 308 is gathered through a choice-based conjoint experiment 106 in the survey 105 that measures the impact on motivation of attributes through utility estimates that make up the reward program. In this experiment, respondents are asked questions that require them to choose among pairs of reward programs that always differ on a small number of program attributes.

After the survey 105 is completed, the collected activity prioritization data 306 and program attribute data 101 is analyzed via HB-MNL 316, 108 to generate a set of utilities 320, 109. These utilities 320, 109 quantify the respondents' preferences and are used to build the decision support tool 200.

The decision support tool 200 is a conjoint simulation that may be implemented in a spreadsheet or other computer program. Through the decision support tool 200, the program owner is provided with a comparison of the first and second reward programs. The comparison communicates to the program owner how many of the participants are more motivated by the first reward program compared to the second reward program. In one embodiment, the decision support tool may be utilized to define multiple reward programs for one or more subgroups of participants. The decision support tool 200 includes a user interface, such as the embodiment illustrated in FIG. 2.

Referring to FIG. 3, the program owner accesses the decision support tool 200. While accessing the decision support tool 200, the program owner is given the opportunity to refine the reward program comparisons by modifying the values of the program attributes and selecting subgroups of participants. This allows the program owner to compare various reward programs and select the reward program that will best motivate the participants. The program owner then selects the reward program 330 that best motivates the participants.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

### Workbook

The left column contains default values. Some possible changes are included in the right column.

| Current Attributes | Potential Changes |
|---|---|
| Trip length | 3, 4, 5 or 7 nights |
| 4, 5 or 7 nights | |
| Hotel type | Test hotel brands |
| Large luxury or small, luxury boutique | |
| All-expenses paid | |
| Yes, no | |
| Destination Type | |
| Domestic, International | |
| Destination Choices | 1 for large group; 3, 4 |
| 1 for large group, 5, 10 or 20 for small group | or 5 for small group |
| Type of Attendees | |
| Guest, guest and children, choice of guest or | |
| guest and children | |
| Big Name Entertainment | |
| Yes, No | |
| Use of Free Time | |
| Leisure time or choice to mix small-group | |
| activities and leisure time | |
| Total Trip Attendees | |
| 50, 100 or 150 for small groups; 500, 1000 or | |
| 2000 for large group | |
| Opportunity to Interact with Senior | |
| Management | |
| None, limited or extensive | |
| Number of Trip Type to Choose From | |
| 1 for large group; 2, 3 or 4 for small group | |
| Choice of Trip Dates | |
| 1 for large group; 2, 3 or 4 for small group | |
| Opportunity to Earn Trip | |
| Limited to pre-set number of attendees or | |
| unlimited - attend if hit pre-set objective | |
| Air Travel Seating | Eliminate first class. |
| Coach, Coach with opportunity to earn first | Add Charter vs. |
| class, First Class | Commercial |
| Length of Award Program | Eliminate question |
| 3, 6 or 12 months | |
| Ability to bank trips? | |
| Travel Groups | Travel with zones, |
| | travel with mix of people |

### Activities to Test

1. Scenic/Nature Tours

2. Historical/Cultural Tours

3. Playing golf

4. Spa/health/wellness activities

5. Beach/sun/watersport activities

6. Shopping—cultural/craft

7. Shopping—general/other

8. Leisure or Unscheduled Time

9. Sporting Events

10. Theme Parks

11. Cultural Lessons

12. Hunting/Fishing

13. Active/Adventure Tours

14. Local Dining/Restaurants

15. Ecotourism

16. Interaction with Popular Entertainers

### Target Segment Definition

Potential segments to analyze on back end of data collection:

Past program earners and non-earners
By area
By tenure
Age
Gender
Ethnicity
Family status (children at home under 18, children over 18, no children, married, single)
Number of times they have qualified in the past
Those who have qualified in the past, but have dropped off

### Appendix B

The following is an example of questions used to create an online survey provided to program element trade-off data to the decision support tool. There are 3 versions of the program tradeoff questions.

Programmer Notes:

Randomly assign respondents so that they receive just one of the three sets of 18 program tradeoff questions: version 1, version 2 or version 3. Within each version, please randomize the order in which the 18 questions appear.

Do not randomize descriptions within questions,
Randomize only the order in which questions appear.

Version 1

Which of these reward trips would you work harder to earn?

| | | |
|---|---|---|
| | Trip Program A | Trip Program B |
| 1_1 | Your choice from among 20 | One destination, selected by your |
| | destinations selected by your | company |
| | company | |
| | Small, luxury boutique-type hotel | Large, luxury hotel |
| | Some portion of meals/activities | All expenses paid |
| | at your expense | |
| | 4-night stay | 5-night stay |
| | International destination | Domestic destination |
| | Trip includes a guest, but not | Trip includes a guest, but not |
| | children | children |
| | No big name entertainment at | Big name entertainment at |
| | gatherings | gatherings |
| | Leisure time on your own to | Choice of small group activities |
| | explore | or leisure time on your own to |
| | | explore |
| | A total of 50 trip attendees | A total of 500 trip attendees |
| | Your choice from among 4 types | 1 type of trip, based on the |
| | of trips selected by your company | destination selected by your |
| | | company |
| | 4 trip dates to choose from | Trip offered on 1 date |
| | No opportunity for face-to-face | Limited opportunity for face-to- |
| | interaction with senior | face interaction with senior |
| | management | management |
| | As many people earn the trip as | A pre-set number of top |
| | achieve their pre-set objective | performers earn the trip |
| | Coach class air travel | Coach class air travel, with the |
| | | opportunity to earn first class |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 1_2 | Your choice from among 5 | One destination, selected by your |
| | destinations selected by your | company |
| | company | |
| | Large, luxury hotel | Large, luxury hotel |
| | All expenses paid | Some portion of meals/activities |
| | | at your expense |
| | 5-night stay | 7-night stay |
| | Domestic destination | International destination |
| | Trip includes a guest, but not | Trip includes a guest, but not |
| | children | children |
| | No big name entertainment at | Big name entertainment at |
| | gatherings | gatherings |
| | Leisure time on your own to | Choice of small group activities |
| | explore | or leisure time on your own to |
| | | explore |
| | A total of 50 trip attendees | A total of 2,000 trip attendees |
| | Your choice from among 4 types | 1 type of trip, based on the |
| | of trips selected by your company | destination selected by your |
| | | company |
| | 2 trip dates to choose from | Trip offered on 1 date |
| | Limited opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 1_3 | Your choice from among 10 | One destination, selected by your |
| | destinations selected by your | company |
| | company | |
| | Large, luxury hotel | Large, luxury hotel |
| | All expenses paid | Some portion of meals/activities |
| | | at your expense |
| | 7-night stay | 4-night stay |
| | Domestic destination | International destination |
| | Trip includes a guest, but not | Trip includes a guest, but not |
| | children | children |
| | No big name entertainment at | Big name entertainment at |
| | gatherings | gatherings |
| | Leisure time on your own to | Choice of small group activities |
| | explore | or leisure time on your own to |
| | | explore |
| | A total of 50 trip attendees | A total of 1,000 trip attendees |
| | Your choice from among 4 types | 1 type of trip, based on the |
| | of trips selected by your company | destination selected by your |
| | | company |
| | 3 trip dates to choose from | Trip offered on 1 date |
| | Extensive opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | First class air travel | Coach class air travel |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 1_4 | Your choice from among 20 | One destination, selected by your |
| | destinations selected by your | company |
| | company | |
| | Small, luxury boutique-type hotel | Large, luxury hotel |
| | Some portion of meals/activities | All expenses paid |
| | at your expense | |
| | 4-night stay | 5-night stay |
| | International destination | Domestic destination |
| | Family trip (able to bring | Trip includes a guest, but not |
| | children) | children |
| | No big name entertainment at | No big name entertainment at |
| | gatherings | gatherings |
| | Choice of small group activities | Leisure time on your own to |
| | or leisure time on your own to | explore |
| | explore | |
| | A total of 100 trip attendees | A total of 1,000 trip attendees |
| | Your choice from among 2 types | 1 type of trip, based on the |
| | of trips selected by your company | destination selected by your |
| | | company |
| | 2 trip dates to choose from | Trip offered on 1 date |
| | Limited opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 1_5 | Your choice from among 5 | One destination, selected by your |
| | destinations selected by your | company |
| | company | |
| | Large, luxury hotel | Large, luxury hotel |
| | All expenses paid | Some portion of meals/activities |
| | | at your expense |
| | 5-night stay | 7-night stay |
| | Domestic destination | International destination |
| | Family trip (able to bring | Trip includes a guest, but not |
| | children) | children |
| | No big name entertainment at | No big name entertainment at |
| | gatherings | gatherings |
| | Choice of small group activities | Leisure time on your own to |
| | or leisure time on your own to | explore |
| | explore | |
| | A total of 100 trip attendees | A total of 500 trip attendees |
| | Your choice from among 2 types | 1 type of trip, based on the |
| | of trips selected by your company | destination selected by your |
| | | company |
| | 3 trip dates to choose from | Trip offered on 1 date |
| | Extensive opportunity for face-to- | Limited opportunity for face-to- |
| | face interaction with senior | face interaction with senior |
| | management | management |
| | A pre-set number of top | As many people earn the trip as |
| | performers earn the trip | achieve their pre-set objective |
| | First class air travel | Coach class air travel |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 1_6 | Your choice from among 10 | One destination, selected by your |
| | destinations selected by your | company |
| | company | |
| | Large, luxury hotel | Large, luxury hotel |
| | All expenses paid | Some portion of meals/activities |
| | | at your expense |
| | 7-night stay | 4-night stay |
| | Domestic destination | International destination |
| | Family trip (able to bring | Trip includes a guest, but not |
| | children) | children |
| | No big name entertainment at | No big name entertainment at |
| | gatherings | gatherings |
| | Choice of small group activities | Leisure time on your own to |
| | or leisure time on your own to | explore |
| | explore | |
| | A total of 100 trip attendees | A total of 2,000 trip attendees |
| | Your choice from among 2 types | 1 type of trip, based on the |
| | of trips selected by your company | destination selected by your |
| | | company |
| | 4 trip dates to choose from | Trip offered on 1 date |
| | No opportunity for face-to-face | No opportunity for face-to-face |
| | interaction with senior | interaction with senior |
| | management | management |
| | As many people earn the trip as | A pre-set number of top |
| | achieve their pre-set objective | performers earn the trip |
| | Coach class air travel, | Coach class air travel, with the |
| | | opportunity to earn first class |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 1_7 | Your choice from among 20 | One destination, selected by your |
| | destinations selected by your | company |
| | company | |
| | Small, luxury boutique-type hotel | Large, luxury hotel |
| | Some portion of meals/activities | All expenses paid |
| | at your expense | |
| | 4-night stay | 5-night stay |
| | International destination | Domestic destination |
| | Your choice of a trip that includes | Trip includes a guest, but not |
| | children or not | children |
| | No big name entertainment at | No big name entertainment at |
| | gatherings | gatherings |
| | Choice of small group activities | Leisure time on your own to |
| | or leisure time on your own to | explore |
| | explore | |
| | A total of 150 trip attendees | A total of 2,000 trip attendees |
| | Your choice from among 3 types | 1 type of trip, based on the |
| | of trips selected by your company | destination selected by your |
| | | company |
| | 3 trip dates to choose from | Trip offered on 1 date |
| | Extensive opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | First class air travel | Coach class air travel |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 1_8 | Your choice from among 5 | One destination, selected by your |
| | destinations selected by your | company |
| | company | |
| | Large, luxury hotel | Large, luxury hotel |
| | All expenses paid | Some portion of meals/activities |
| | | at your expense |
| | 5-night stay | 7-night stay |
| | Domestic destination | International destination |
| | Your choice of a trip that includes | Trip includes a guest, but not |
| | children or not | children |
| | No big name entertainment at | No big name entertainment at |
| | gatherings | gatherings |
| | Choice of small group activities | Leisure time on your own to |
| | or leisure time on your own to | explore |
| | explore | |
| | A total of 150 trip attendees | A total of 1,000 trip attendees |
| | Your choice from among 3 types | 1 type of trip, based on the |
| | of trips selected by your company | destination selected by your |
| | | company |
| | 4 trip dates to choose from | Trip offered on 1 date |
| | No opportunity for face-to-face | No opportunity for face-to-face |
| | interaction with senior | interaction with senior |
| | management | management |
| | As many people earn the trip as | A pre-set number of top |
| | achieve their pre-set objective | performers earn the trip |
| | Coach class air travel | Coach class air travel, with the |
| | | opportunity to earn first class |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 1_9 | Your choice from among 10 | One destination, selected by your |
| | destinations selected by your | company |
| | company | |
| | Large, luxury hotel | Large, luxury hotel |
| | All expenses paid | Some portion of meals/activities |
| | | at your expense |
| | 7-night stay | 4-night stay |
| | Domestic destination | International destination |
| | Your choice of a trip that includes | Trip includes a guest, but not |
| | children or not | children |
| | No big name entertainment at | No big name entertainment at |
| | gatherings | gatherings |
| | Choice of small group activities | Leisure time on your own to |
| | or leisure time on your own to | explore |
| | explore | |
| | A total of 150 trip attendees | A total of 500 trip attendees |
| | Your choice from among 3 types | 1 type of trip, based on the |
| | of trips selected by your company | destination selected by your |
| | | company |
| | 2 trip dates to choose from | Trip offered on 1 date |
| | Limited opportunity for face-to- | Limited opportunity for face-to- |
| | face interaction with senior | face interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 1_10 | Your choice from among 20 | One destination, selected by your |
| | destinations selected by your | company |
| | company | |
| | Large, luxury hotel | Large, luxury hotel |
| | All expenses paid | Some portion of meals/activities |
| | | at your expense |
| | 7-night stay | 4-night stay |
| | Domestic destination | International destination |
| | Trip includes a guest, but not | Trip includes a guest, but not |
| | children | children |
| | No big name entertainment at | No big name entertainment at |
| | gatherings | gatherings |
| | Choice of small group activities | Leisure time on your own to |
| | or leisure time on your own to | explore |
| | explore | |
| | A total of 150 trip attendees | A total of 500 trip attendees |
| | Your choice from among 3 types | 1 type of trip, based on the |
| | of trips selected by your company | destination selected by your |
| | | company |
| | 4 trip dates to choose from | Trip offered on 1 date |
| | Limited opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | First class air travel | Coach class air travel |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 1_11 | Your choice from among 5 | One destination, selected by your |
| | destinations selected by your | company |
| | company | |
| | Large, luxury hotel | Large, luxury hotel |
| | All expenses paid | Some portion of meals/activities |
| | | at your expense |
| | 4-night stay | 5-night stay |
| | International destination | Domestic destination |
| | Trip includes a guest, but not | Trip includes a guest, but not |
| | children | children |
| | No big name entertainment at | No big name entertainment at |
| | gatherings | gatherings |
| | Choice of small group activities | Leisure time on your own to |
| | or leisure time on your own to | explore |
| | explore | |
| | A total of 150 trip attendees | A total of 2,000 trip attendees |
| | Your choice from among 3 types | 1 type of trip, based on the |
| | of trips selected by your company | destination selected by your |
| | | company |
| | 2 trip dates to choose from | Trip offered on 1 date |
| | Extensive opportunity for face-to- | Limited opportunity for face-to- |
| | face interaction with senior | face interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 1_12 | Your choice from among 10 | One destination, selected by your |
| | destinations selected by your | company |
| | company | |
| | Small, luxury boutique-type hotel | Large, luxury hotel |
| | Some portion of meals/activities | All expenses paid |
| | at your expense | |
| | 5-night stay | 7-night stay |
| | Domestic destination | International destination |
| | Trip includes a guest, but not | Trip includes a guest, but not |
| | children | children |
| | No big name entertainment at | No big name entertainment at |
| | gatherings | gatherings |
| | Choice of small group activities | Leisure time on your own to |
| | or leisure time on your own to | explore |
| | explore | |
| | A total of 150 trip attendees | A total of 1,000 trip attendees |
| | Your choice from among 3 types | 1 type of trip, based on the |
| | of trips selected by your company | destination selected by your |
| | | company |
| | 3 trip dates to choose from | Trip offered on 1 date |
| | No opportunity for face-to-face | No opportunity for face-to-face |
| | interaction with senior | interaction with senior |
| | management | management |
| | As many people earn the trip as | A pre-set number of top |
| | achieve their pre-set objective | performers earn the trip |
| | Coach class air travel, with the | Coach class air travel |
| | opportunity to earn first class | |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 1_13 | Your choice from among 20 | One destination, selected by your |
| | destinations selected by your | company |
| | company | |
| | Large, luxury hotel | Large, luxury hotel |
| | All expenses paid | Some portion of meals/activities |
| | | at your expense |
| | 7-night stay | 4-night stay |
| | Domestic destination | International destination |
| | Family trip (able to bring | Trip includes a guest, but not |
| | children) | children |
| | No big name entertainment at | No big name entertainment at |
| | gatherings | gatherings |
| | Choice of small group activities | Leisure time on your own to |
| | or leisure time on your own to | explore |
| | explore | |
| | A total of 50 trip attendees | A total of 1,000 trip attendees |
| | Your choice from among 4 types | 1 type of trip, based on the |
| | of trips selected by your company | destination selected by your |
| | | company |
| | 2 trip dates to choose from | Trip offered on 1 date |
| | Extensive opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 1_14 | Your choice from among 5 | One destination, selected by your |
| | destinations selected by your | company |
| | company | |
| | Large, luxury hotel | Large, luxury hotel |
| | All expenses paid | Some portion of meals/activities |
| | | at your expense |
| | 4-night stay | 5-night stay |
| | International destination | Domestic destination |
| | Family trip (able to bring | Trip includes a guest, but not |
| | children) | children |
| | No big name entertainment at | No big name entertainment at |
| | gatherings | gatherings |
| | Choice of small group activities | Leisure time on your own to |
| | or leisure time on your own to | explore |
| | explore | |
| | A total of 50 trip attendees | A total of 500 trip attendees |
| | Your choice from among 4 types | 1 type of trip, based on the |
| | of trips selected by your company | destination selected by your |
| | | company |
| | 3 trip dates to choose from | Trip offered on 1 date |
| | No opportunity for face-to-face | No opportunity for face-to-face |
| | interaction with senior | interaction with senior |
| | management | management |
| | As many people earn the trip as | A pre-set number of top |
| | achieve their pre-set objective | performers earn the trip |
| | Coach class air travel, with the | Coach class air travel |
| | opportunity to earn first class | |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 1_15 | Your choice from among 10 | One destination, selected by your |
| | destinations selected by your | company |
| | company | |
| | Small, luxury boutique-type hotel | Large, luxury hotel |
| | Some portion of meals/activities | All expenses paid |
| | at your expense | |
| | 5-night stay | 7-night stay |
| | Domestic destination | International destination |
| | Family trip (able to bring | Trip includes a guest, but not |
| | children) | children |
| | No big name entertainment at | No big name entertainment at |
| | gatherings | gatherings |
| | Choice of small group activities | Leisure time on your own to |
| | or leisure time on your own to | explore |
| | explore | |
| | A total of 50 trip attendees | A total of 2,000 trip attendees |
| | Your choice from among 4 types | 1 type of trip, based on the |
| | of trips selected by your company | destination selected by your |
| | | company |
| | 4 trip dates to choose from | Trip offered on 1 date |
| | Limited opportunity for face-to- | Limited opportunity for face-to- |
| | face interaction with senior | face interaction with senior |
| | management | management |
| | A pre-set number of top | As many people earn the trip as |
| | performers earn the trip | achieve their pre-set objective |
| | First class air travel | Coach class air travel |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 1_16 | Your choice from among 20 | One destination, selected by your |
| | destinations selected by your | company |
| | company | |
| | Large, luxury hotel | Large, luxury hotel |
| | All expenses paid | Some portion of meals/activities |
| | | at your expense |
| | 7-night stay | 4-night stay |
| | Domestic destination | International destination |
| | Your choice of a trip that includes | Trip includes a guest, but not |
| | children or not | children |
| | No big name entertainment at | Big name entertainment at |
| | gatherings | gatherings |
| | Leisure time on your own to | Choice of small group activities |
| | explore | or leisure time on your own to |
| | | explore |
| | A total of 100 trip attendees | A total of 2,000 trip attendees |
| | Your choice from among 2 types | 1 type of trip, based on the |
| | of trips selected by your company | destination selected by your |
| | | company |
| | 3 trip dates to choose from | Trip offered on 1 date |
| | No opportunity for face-to-face | Limited opportunity for face-to |
| | interaction with senior | face interaction with senior |
| | management | management |
| | As many people earn the trip as | A pre-set number of top |
| | achieve their pre-set objective | performers earn the trip |
| | Coach class air travel, with the | Coach class air travel |
| | opportunity to earn first class | |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 1_17 | Your choice from among 5 | One destination, selected by your |
| | destinations selected by your | company |
| | company | |
| | Large, luxury hotel | Large, luxury hotel |
| | All expenses paid | Some portion of meals/activities |
| | | at your expense |
| | 4-night stay | 5-night stay |
| | International destination | Domestic destination |
| | Your choice of a trip that includes | Trip includes a guest, but not |
| | children or not | children |
| | No big name entertainment at | Big name entertainment at |
| | gatherings | gatherings |
| | Leisure time on your own to | Choice of small group activities |
| | explore | or leisure time on your own to |
| | | explore |
| | A total of 100 trip attendees | A total of 1,000 trip attendees |
| | Your choice from among 2 types | 1 type of trip, based on the |
| | of trips selected by your company | destination selected by your |
| | | company |
| | 4 trip dates to choose from | Trip offered on 1 date |
| | Limited opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | First class air travel | Coach class air travel |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 1_18 | Your choice from among 10 | One destination, selected by your |
| | destinations selected by your | company |
| | company | |
| | Small, luxury boutique-type hotel | Large, luxury hotel |
| | Some portion of meals/activities | All expenses paid |
| | at your expense | |
| | 5-night stay | 7-night stay |
| | Domestic destination | International destination |
| | Your choice of a trip that includes | Trip includes a guest, but not |
| | children or not | children |
| | No big name entertainment at | Big name entertainment at |
| | gatherings | gatherings |
| | Leisure time on your own to | Choice of small group activities |
| | explore | or leisure time on your own to |
| | | explore |
| | A total of 100 trip attendees | A total of 500 trip attendees |
| | Your choice from among 2 types | 1 type of trip, based on the |
| | of trips selected by your company | destination selected by your |
| | | company |
| | 2 trip dates to choose from | Trip offered on 1 date |
| | Extensive opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 3 | Program to earn reward is 6 |
| | months long | months long |
| I would choose | A [ ] | B [ ] |

Version 2

Which of these reward trips would you work harder to earn?

| | | |
|---|---|---|
| | Trip Program A | Trip Program B |
| 2_1 | Your choice from among 5 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 7-night stay | 4-night stay |
| | Domestic destination | International destination |
| | Family trip (able to bring | Trip includes a guest, but not |
| | children) | children |
| | No big name entertainment at | Big name entertainment at |
| | gatherings | gatherings |
| | Choice of small group activities | Leisure time on your own to |
| | or leisure time on your own to | explore |
| | explore | |
| | A total of 150 trip attendees | A total of 1,000 trip attendees |
| | Your choice from among 2 types | 1 type of trip, based on the |
| | of trips selected by your company | destination selected by your |
| | | company |
| | 2 trip dates to choose from | Trip offered on 1 date |
| | No opportunity for face-to-face | Limited opportunity for face-to- |
| | interaction with senior | face interaction with senior |
| | management | management |
| | A pre-set number of top | As many people earn the trip as |
| | performers earn the trip | achieve their pre-set objective |
| | First class air travel | Coach class air travel |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 2_2 | Your choice from among 10 | One destination, selected by your |
| | destinations selected by your | company |
| | company | |
| | Large, luxury hotel | Large, luxury hotel |
| | Some portion of meals/activities | All expenses paid |
| | at your expense | |
| | 4-night stay | 5-night stay |
| | Domestic destination | International destination |
| | Family trip (able to bring | Trip includes a guest, but not |
| | children) | children |
| | No big name entertainment at | Big name entertainment at |
| | gatherings | gatherings |
| | Choice of small group activities | Leisure time on your own to |
| | or leisure time on your own to | explore |
| | explore | |
| | A total of 150 trip attendees | A total of 500 trip attendees |
| | Your choice from among 2 types | 1 type of trip, based on the |
| | of trips selected by your company | destination selected by your |
| | | company |
| | 3 trip dates to choose from | Trip offered on 1 date |
| | Limited opportunity for face-to- | No opportunity for face-to-face |
| | face interaction with senior | interaction with senior |
| | management | management |
| | As many people earn the trip as | A pre-set number of top |
| | achieve their pre-set objective | performers earn the trip |
| | Coach class air travel | Coach class air travel, with the |
| | | opportunity to earn first class |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 2_3 | Your choice from among 20 | One destination, selected by your |
| | destinations selected by your | company |
| | company | |
| | Large, luxury hotel | Large, luxury hotel |
| | All expenses paid | Some portion of meals/activities |
| | | at your expense |
| | 5-night stay | 7-night stay |
| | International destination | Domestic destination |
| | Family trip (able to bring | Trip includes a guest, but not |
| | children) | children |
| | No big name entertainment at | Big name entertainment at |
| | gatherings | gatherings |
| | Choice of small group activities | Leisure time on your own to |
| | or leisure time on your own to | explore |
| | explore | |
| | A total of 150 trip attendees | A total of 2,000 trip attendees |
| | Your choice from among 2 types | 1 type of trip, based on the |
| | of trips selected by your company | destination selected by your |
| | | company |
| | 4 trip dates to choose from | Trip offered on 1 date |
| | Extensive opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 2_4 | Your choice from among 5 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 7-night stay | 4-night stay |
| | Domestic destination | International destination |
| | Your choice of a trip that includes | Trip includes a guest, but not |
| | children or not | children |
| | No big name entertainment at | No big name entertainment at |
| | gatherings | gatherings |
| | Leisure time on your own to | Choice of small group activities |
| | explore | or leisure time on your own to |
| | | explore |
| | A total of 50 trip attendees | A total of 2,000 trip attendees |
| | Your choice from among 3 types | 1 type of trip, based on the |
| | of trips selected by your company | destination selected by your |
| | | company |
| | 3 trip dates to choose from | Trip offered on 1 date |
| | Limited opportunity for face-to- | No opportunity for face-to-face |
| | face interaction with senior | interaction with senior |
| | management | management |
| | As many people earn the trip as | A pre-set number of top |
| | achieve their pre-set objective | performers earn the trip |
| | Coach class air travel | Coach class air travel, with the |
| | | opportunity to earn first class |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 2_5 | Your choice from among 10 | One destination, selected by your |
| | destinations selected by your | company |
| | company | |
| | Large, luxury hotel | Large, luxury hotel |
| | Some portion of meals/activities | All expenses paid |
| | at your expense | |
| | 4-night stay | 5-night stay |
| | Domestic destination | International destination |
| | Your choice of a trip that includes | Trip includes a guest, but not |
| | children or not | children |
| | No big name entertainment at | No big name entertainment at |
| | gatherings | gatherings |
| | Leisure time on your own to | Choice of small group activities |
| | explore | or leisure time on your own to |
| | | explore |
| | A total of 50 trip attendees | A total of 1,000 trip attendees |
| | Your choice from among 3 types | 1 type of trip, based on the |
| | of trips selected by your company | destination selected by your |
| | | company |
| | 4 trip dates to choose from | Trip offered on 1 date |
| | Extensive opportunity for face-to- | Limited opportunity for face-to- |
| | face interaction with senior | face interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 2_6 | Your choice from among 20 | One destination, selected by your |
| | destinations selected by your | company |
| | company | |
| | Large, luxury hotel | Large, luxury hotel |
| | All expenses paid | Some portion of meals/activities |
| | | at your expense |
| | 5-night stay | 7-night stay |
| | International destination | Domestic destination |
| | Your choice of a trip that includes | Trip includes a guest, but not |
| | children or not | children |
| | No big name entertainment at | No big name entertainment at |
| | gatherings | gatherings |
| | Leisure time on your own to | Choice of small group activities |
| | explore | or leisure time on your own to |
| | | explore |
| | A total of 50 trip attendees | A total of 500 trip attendees |
| | Your choice from among 3 types | 1 type of trip, based on the |
| | of trips selected by your company | destination selected by your |
| | | company |
| | 2 trip dates to choose from | Trip offered on 1 date |
| | No opportunity for face-to-face | No opportunity for face-to-face |
| | interaction with senior | interaction with senior |
| | management | management |
| | A pre-set number of top | As many people earn the trip as |
| | performers earn the trip | achieve their pre-set objective |
| | First class air travel | Coach class air travel |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 2_7 | Your choice from among 5 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 7-night stay | 4-night stay |
| | Domestic destination | International destination |
| | Trip includes a guest, but not | Trip includes a guest, but not |
| | children | children |
| | No big name entertainment at | No big name entertainment at |
| | gatherings | gatherings |
| | Choice of small group activities | Leisure time on your own to |
| | or leisure time on your own to | explore |
| | explore | |
| | A total of 100 trip attendees | A total of 500 trip attendees |
| | Your choice from among 4 types | 1 type of trip, based on the |
| | of trips selected by your company | destination selected by your |
| | | company |
| | 4 trip dates to choose from | Trip offered on 1 date |
| | Extensive opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 2_8 | Your choice from among 10 | One destination, selected by your |
| | destinations selected by your | company |
| | company | |
| | Large, luxury hotel | Large, luxury hotel |
| | Some portion of meals/activities | All expenses paid |
| | at your expense | |
| | 4-night stay | 5-night stay |
| | Domestic destination | International destination |
| | Trip includes a guest, but not | Trip includes a guest, but not |
| | children | children |
| | No big name entertainment at | No big name entertainment at |
| | gatherings | gatherings |
| | Choice of small group activities | Leisure time on your own to |
| | or leisure time on your own to | explore |
| | explore | |
| | A total of 100 trip attendees | A total of 2,000 trip attendees |
| | Your choice from among 4 types | 1 type of trip, based on the |
| | of trips selected by your company | destination selected by your |
| | | company |
| | 2 trip dates to choose from | Trip offered on 1 date |
| | No opportunity for face-to-face | No opportunity for face-to-face |
| | interaction with senior | interaction with senior |
| | management | management |
| | A pre-set number of top | As many people earn the trip as |
| | performers earn the trip | achieve their pre-set objective |
| | First class air travel | Coach class air travel |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 2_9 | Your choice from among 20 | One destination, selected by your |
| | destinations selected by your | company |
| | company | |
| | Large, luxury hotel | Large, luxury hotel |
| | All expenses paid | Some portion of meals/activities |
| | | at your expense |
| | 5-night stay | 7-night stay |
| | International destination | Domestic destination |
| | Trip includes a guest, but not | Trip includes a guest, but not |
| | children | children |
| | No big name entertainment at | No big name entertainment at |
| | gatherings | gatherings |
| | Choice of small group activities | Leisure time on your own to |
| | or leisure time on your own to | explore |
| | explore | |
| | A total of 100 trip attendees | A total of 1,000 trip attendees |
| | Your choice from among 4 types | 1 type of trip, based on the |
| | of trips selected by your company | destination selected by your |
| | | company |
| | 3 trip dates to choose from | Trip offered on 1 date |
| | Limited opportunity for face-to- | Limited opportunity for face-to- |
| | face interaction with senior | face interaction with senior |
| | management | management |
| | As many people earn the trip as | A pre-set number of top |
| | achieve their pre-set objective | performers earn the trip |
| | Coach class air travel | Coach class air travel, with the |
| | | opportunity to earn first class |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 2_10 | Your choice from among 5 | One destination, selected by your |
| | destinations selected by your | company |
| | company | |
| | Large, luxury hotel | Large, luxury hotel |
| | Some portion of meals/activities | All expenses paid |
| | at your expense | |
| | 5-night stay | 7-night stay |
| | Domestic destination | International destination |
| | Family trip (able to bring | Trip includes a guest, but not |
| | children) | children |
| | No big name entertainment at | No big name entertainment at |
| | gatherings | gatherings |
| | Leisure time on your own to | Choice of small group activities |
| | explore | or leisure time on your own to |
| | | explore |
| | A total of 100 trip attendees | A total of 1,000 trip attendees |
| | Your choice from among 3 types | 1 type of trip, based on the |
| | of trips selected by your company | destination selected by your |
| | | company |
| | 2 trip dates to choose from | Trip offered on 1 date |
| | Extensive opportunity for face-to- | No opportunity for face-to-face |
| | face interaction with senior | interaction with senior |
| | management | management |
| | As many people earn the trip as | A pre-set number of top |
| | achieve their pre-set objective | performers earn the trip |
| | Coach class air travel, with the | Coach class air travel |
| | opportunity to earn first class | |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 2_11 | Your choice from among 10 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 7-night stay | 4-night stay |
| | International destination | Domestic destination |
| | Family trip (able to bring | Trip includes a guest, but not |
| | children) | children |
| | No big name entertainment at | No big name entertainment at |
| | gatherings | gatherings |
| | Leisure time on your own to | Choice of small group activities |
| | explore | or leisure time on your own to |
| | | explore |
| | A total of 100 trip attendees | A total of 500 trip attendees |
| | Your choice from among 3 types | 1 type of trip, based on the |
| | of trips selected by your company | destination selected by your |
| | | company |
| | 3 trip dates to choose from | Trip offered on 1 date |
| | No opportunity for face-to-face | No opportunity for face-to-face |
| | interaction with senior | interaction with senior |
| | management | management |
| | A pre-set number of top | As many people earn the trip as |
| | performers earn the trip | achieve their pre-set objective |
| | First class air travel | Coach class air travel |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 2_12 | Your choice from among 20 | One destination, selected by your |
| | destinations selected by your | company |
| | company | |
| | Large, luxury hotel | Large, luxury hotel |
| | All expenses paid | Some portion of meals/activities |
| | | at your expense |
| | 4-night stay | 5-night stay |
| | Domestic destination | International destination |
| | Family trip (able to bring | Trip includes a guest, but not |
| | children) | children |
| | No big name entertainment at | No big name entertainment at |
| | gatherings | gatherings |
| | Leisure time on your own to | Choice of small group activities |
| | explore | or leisure time on your own to |
| | | explore |
| | A total of 100 trip attendees | A total of 2,000 trip attendees |
| | Your choice from among 3 types | 1 type of trip, based on the |
| | of trips selected by your company | destination selected by your |
| | | company |
| | 4 trip dates to choose from | Trip offered on 1 date |
| | Limited opportunity for face-to- | Limited opportunity for face-to- |
| | face interaction with senior | face interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 2_13 | Your choice from among 5 | One destination, selected by your |
| | destinations selected by your | company |
| | company | |
| | Large, luxury hotel | Large, luxury hotel |
| | Some portion of meals/activities | All expenses paid |
| | at your expense | |
| | 5-night stay | 7-night stay |
| | Domestic destination | International destination |
| | Your choice of a trip that includes | Trip includes a guest, but not |
| | children or not | children |
| | No big name entertainment at | Big name entertainment at |
| | gatherings | gatherings |
| | Choice of small group activities | Leisure time on your own to |
| | or leisure time on your own to | explore |
| | explore | |
| | A total of 150 trip attendees | A total of 2,000 trip attendees |
| | Your choice from among 4 types | 1 type of trip, based on the |
| | of trips selected by your company | destination selected by your |
| | | company |
| | 3 trip dates to choose from | Trip offered on 1 date |
| | No opportunity for face-to-face | Limited opportunity for face-to- |
| | interaction with senior | face interaction with senior |
| | management | management |
| | A pre-set number of top | As many people earn the trip as |
| | performers earn the trip | achieve their pre-set objective |
| | First class air travel | Coach class air travel |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 2_14 | Your choice from among 10 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 7-night stay | 4-night stay |
| | International destination | Domestic destination |
| | Your choice of a trip that includes | Trip includes a guest, but not |
| | children or not | children |
| | No big name entertainment at | Big name entertainment at |
| | gatherings | gatherings |
| | Choice of small group activities | Leisure time on your own to |
| | or leisure time on your own to | explore |
| | explore | |
| | A total of 150 trip attendees | A total of 1,000 trip attendees |
| | Your choice from among 4 types | 1 type of trip, based on the |
| | of trips selected by your company | destination selected by your |
| | | company |
| | 4 trip dates to choose from | Trip offered on 1 date |
| | Limited opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 2_15 | Your choice from among 20 | One destination, selected by your |
| | destinations selected by your | company |
| | company | |
| | Large, luxury hotel | Large, luxury hotel |
| | All expenses paid | Some portion of meals/activities |
| | | at your expense |
| | 4-night stay | 5-night stay |
| | Domestic destination | International destination |
| | Your choice of a trip that includes | Trip includes a guest, but not |
| | children or not | children |
| | No big name entertainment at | Big name entertainment at |
| | gatherings | gatherings |
| | Choice of small group activities | Leisure time on your own to |
| | or leisure time on your own to | explore |
| | explore | |
| | A total of 150 trip attendees | A total of 500 trip attendees |
| | Your choice from among 4 types | 1 type of trip, based on the |
| | of trips selected by your company | destination selected by your |
| | | company |
| | 2 trip dates to choose from | Trip offered on 1 date |
| | Extensive opportunity for face-to- | No opportunity for face-to-face |
| | face interaction with senior | interaction with senior |
| | management | management |
| | As many people earn the trip as | A pre-set number of top |
| | achieve their pre-set objective | performers earn the trip |
| | Coach class air travel, with the | Coach class air travel |
| | opportunity to earn first class | |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 2_16 | Your choice from among 5 | One destination, selected by your |
| | destinations selected by your | company |
| | company | |
| | Large, luxury hotel | Large, luxury hotel |
| | Some portion of meals/activities | All expenses paid |
| | at your expense | |
| | 5-night stay | 7-night stay |
| | Domestic destination | International destination |
| | Trip includes a guest, but not | Trip includes a guest, but not |
| | children | children |
| | No big name entertainment at | No big name entertainment at |
| | gatherings | gatherings |
| | Choice of small group activities | Leisure time on your own to |
| | or leisure time on your own to | explore |
| | explore | |
| | A total of 50 trip attendees | A total of 500 trip attendees |
| | Your choice from among 2 types | 1 type of trip, based on the |
| | of trips selected by your company | destination selected by your |
| | | company |
| | 4 trip dates to choose from | Trip offered on 1 date |
| | Limited opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 2_17 | Your choice from among 10 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 7-night stay | 4-night stay |
| | International destination | Domestic destination |
| | Trip includes a guest, but not | Trip includes a guest, but not |
| | children | children |
| | No big name entertainment at | No big name entertainment at |
| | gatherings | gatherings |
| | Choice of small group activities | Leisure time on your own to |
| | or leisure time on your own to | explore |
| | explore | |
| | A total of 50 trip attendees | A total of 2,000 trip attendees |
| | Your choice from among 2 types | 1 type of trip, based on the |
| | of trips selected by your company | destination selected by your |
| | | company |
| | 2 trip dates to choose from | Trip offered on 1 date |
| | Extensive opportunity for face-to- | Limited opportunity for face-to- |
| | face interaction with senior | face interaction with senior |
| | management | management |
| | As many people earn the trip as | A pre-set number of top |
| | achieve their pre-set objective | performers earn the trip |
| | Coach class air travel, with the | Coach class air travel |
| | opportunity to earn first class | |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 2_18 | Your choice from among 20 | One destination, selected by your |
| | destinations selected by your | company |
| | company | |
| | Large, luxury hotel | Large, luxury hotel |
| | All expenses paid | Some portion of meals/activities |
| | | at your expense |
| | 4-night stay | 5-night stay |
| | Domestic destination | International destination |
| | Trip includes a guest, but not | Trip includes a guest, but not |
| | children | children |
| | No big name entertainment at | No big name entertainment at |
| | gatherings | gatherings |
| | Choice of small group activities | Leisure time on your own to |
| | or leisure time on your own to | explore |
| | explore | |
| | A total of 50 trip attendees | A total of 1,000 trip attendees |
| | Your choice from among 2 types | 1 type of trip, based on the |
| | of trips selected by your company | destination selected by your |
| | | company |
| | 3 trip dates to choose from | Trip offered on 1 date |
| | No opportunity for face-to-face | No opportunity for face-to-face |
| | interaction with senior | interaction with senior |
| | management | management |
| | A pre-set number of top | As many people earn the trip as |
| | performers earn the trip | achieve their pre-set objective |
| | First class air travel | Coach class air travel |
| | Program to earn reward is 3 | Program to earn reward is 6 |
| | months long | months long |
| I would choose | A [ ] | B [ ] |

Version 3

Which of these reward trips would you work harder to earn?

| | | |
|---|---|---|
| | Trip Program A | Trip Program B |
| 3_1 | Your choice from among 10 | One destination, selected by your |
| | destinations selected by your | company |
| | company | |
| | Large, luxury hotel | Large, luxury hotel |
| | All expenses paid | Some portion of meals/activities |
| | | at your expense |
| | 5-night stay | 7-night stay |
| | International destination | Domestic destination |
| | Your choice of a trip that includes | Trip includes a guest, but not |
| | children or not | children |
| | No big name entertainment at | No big name entertainment at |
| | gatherings | gatherings |
| | Choice of small group activities | Leisure time on your own to |
| | or leisure time on your own to | explore |
| | explore | |
| | A total of 100 trip attendees | A total of 2,000 trip attendees |
| | Your choice from among 4 types | 1 type of trip, based on the |
| | of trips selected by your company | destination selected by your |
| | | company |
| | 3 trip dates to choose from | Trip offered on 1 date |
| | Limited opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 3_2 | Your choice from among 20 | One destination, selected by your |
| | destinations selected by your | company |
| | company | |
| | Large, luxury hotel | Large, luxury hotel |
| | Some portion of meals/activities | All expenses paid |
| | at your expense | |
| | 7-night stay | 4-night stay |
| | Domestic destination | International destination |
| | Your choice of a trip that includes | Trip includes a guest, but not |
| | children or not | children |
| | No big name entertainment at | No big name entertainment at |
| | gatherings | gatherings |
| | Choice of small group activities | Leisure time on your own to |
| | or leisure time on your own to | explore |
| | explore | |
| | A total of 100 trip attendees | A total of 1,000 trip attendees |
| | Your choice from among 4 types | 1 type of trip, based on the |
| | of trips selected by your company | destination selected by your |
| | | company |
| | 4 trip dates to choose from | Trip offered on 1 date |
| | Extensive opportunity for face-to- | Limited opportunity for face-to |
| | face interaction with senior | face interaction with senior |
| | management | management |
| | As many people earn the trip as | A pre-set number of top |
| | achieve their pre-set objective | performers earn the trip |
| | First class air travel | Coach class air travel |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 3_3 | Your choice from among 5 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 4-night stay | 5-night stay |
| | Domestic destination | International destination |
| | Your choice of a trip that includes | Trip includes a guest, but not |
| | children or not | children |
| | No big name entertainment at | No big name entertainment at |
| | gatherings | gatherings |
| | Choice of small group activities | Leisure time on your own to |
| | or leisure time on your own to | explore |
| | explore | |
| | A total of 100 trip attendees | A total of 500 trip attendees |
| | Your choice from among 4 types | 1 type of trip, based on the |
| | of trips selected by your company | destination selected by your |
| | | company |
| | 2 trip dates to choose from | Trip offered on 1 date |
| | No opportunity for face-to-face | No opportunity for face-to-face |
| | interaction with senior | interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 3_4 | Your choice from among 10 | One destination, selected by your |
| | destinations selected by your | company |
| | company | |
| | Large, luxury hotel | Large, luxury hotel |
| | All expenses paid | Some portion of meals/activities |
| | | at your expense |
| | 5-night stay | 7-night stay |
| | International destination | Domestic destination |
| | Trip includes a guest, but not | Trip includes a guest, but not |
| | children | children |
| | No big name entertainment at | No big name entertainment at |
| | gatherings | gatherings |
| | Leisure time on your own to | Choice of small group activities |
| | explore | or leisure time on your own to |
| | | explore |
| | A total of 150 trip attendees | A total of 500 trip attendees |
| | Your choice from among 2 types | 1 type of trip, based on the |
| | of trips selected by your company | destination selected by your |
| | | company |
| | 4 trip dates to choose from | Trip offered on 1 date |
| | Extensive opportunity for face-to- | No opportunity for face-to-face |
| | face interaction with senior | interaction with senior |
| | management | management |
| | As many people earn the trip as | A pre-set number of top |
| | achieve their pre-set objective | performers earn the trip |
| | First class air travel | Coach class air travel |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 3_5 | Your choice from among 20 | One destination, selected by your |
| | destinations selected by your | company |
| | company | |
| | Large, luxury hotel | Large, luxury hotel |
| | Some portion of meals/activities | All expenses paid |
| | at your expense | |
| | 7-night stay | 4-night stay |
| | Domestic destination | International destination |
| | Trip includes a guest, but not | Trip includes a guest, but not |
| | children | children |
| | No big name entertainment at | No big name entertainment at |
| | gatherings | gatherings |
| | Leisure time on your own to | Choice of small group activities |
| | explore | or leisure time on your own to |
| | | explore |
| | A total of 150 trip attendees | A total of 2,000 trip attendees |
| | Your choice from among 2 types | 1 type of trip, based on the |
| | of trips selected by your company | destination selected by your |
| | | company |
| | 2 trip dates to choose from | Trip offered on 1 date |
| | No opportunity for face-to-face | No opportunity for face-to-face |
| | interaction with senior | interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 3_6 | Your choice from among 5 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 4-night stay | 5-night stay |
| | Domestic destination | International destination |
| | Trip includes a guest, but not | Trip includes a guest, but not |
| | children | children |
| | No big name entertainment at | No big name entertainment at |
| | gatherings | gatherings |
| | Leisure time on your own to | Choice of small group activities |
| | explore | or leisure time on your own to |
| | | explore |
| | A total of 150 trip attendees | A total of 1,000 trip attendees |
| | Your choice from among 2 types | 1 type of trip, based on the |
| | of trips selected by your company | destination selected by your |
| | | company |
| | 3 trip dates to choose from | Trip offered on 1 date |
| | Limited opportunity for face-to- | Limited opportunity for face-to- |
| | face interaction with senior | face interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 3_7 | Your choice from among 10 | One destination, selected by your |
| | destinations selected by your | company |
| | company | |
| | Large, luxury hotel | Large, luxury hotel |
| | All expenses paid | Some portion of meals/activities |
| | | at your expense |
| | 5-night stay | 7-night stay |
| | International destination | Domestic destination |
| | Family trip (able to bring | Trip includes a guest, but not |
| | children) | children |
| | No big name entertainment at | Big name entertainment at |
| | gatherings | gatherings |
| | Choice of small group activities | Leisure time on your own to |
| | or leisure time on your own to | explore |
| | explore | |
| | A total of 50 trip attendees | A total of 1,000 trip attendees |
| | Your choice from among 3 types | 1 type of trip, based on the |
| | of trips selected by your company | destination selected by your |
| | | company |
| | 2 trip dates to choose from | Trip offered on 1 date |
| | No opportunity for face-to-face | Limited opportunity for face-to- |
| | interaction with senior | face interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 3_8 | Your choice from among 20 | One destination, selected by your |
| | destinations selected by your | company |
| | company | |
| | Large, luxury hotel | Large, luxury hotel |
| | Some portion of meals/activities | All expenses paid |
| | at your expense | |
| | 7-night stay | 4-night stay |
| | Domestic destination | International destination |
| | Family trip (able to bring | Trip includes a guest, but not |
| | children) | children |
| | No big name entertainment at | Big name entertainment at |
| | gatherings | gatherings |
| | Choice of small group activities | Leisure time on your own to |
| | or leisure time on your own to | explore |
| | explore | |
| | A total of 50 trip attendees | A total of 500 trip attendees |
| | Your choice from among 3 types | 1 type of trip, based on the |
| | of trips selected by your company | destination selected by your |
| | | company |
| | 3 trip dates to choose from | Trip offered on 1 date |
| | Limited opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 3_9 | Your choice from among 5 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 4-night stay | 5-night stay |
| | Domestic destination | International destination |
| | Family trip (able to bring | Trip includes a guest, but not |
| | children) | children |
| | No big name entertainment at | Big name entertainment at |
| | gatherings | gatherings |
| | Choice of small group activities | Leisure time on your own to |
| | or leisure time on your own to | explore |
| | explore | |
| | A total of 50 trip attendees | A total of 2,000 trip attendees |
| | Your choice from among 3 types | 1 type of trip, based on the |
| | of trips selected by your company | destination selected by your |
| | | company |
| | 4 trip dates to choose from | Trip offered on 1 date |
| | Extensive opportunity for face-to- | No opportunity for face-to-face |
| | face interaction with senior | interaction with senior |
| | management | management |
| | As many people earn the trip as | A pre-set number of top |
| | achieve their pre-set objective | performers earn the trip |
| | First class air travel | Coach class air travel |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 3_10 | Your choice from among 10 | One destination, selected by your |
| | destinations selected by your | company |
| | company | |
| | Large, luxury hotel | Large, luxury hotel |
| | All expenses paid | Some portion of meals/activities |
| | | at your expense |
| | 4-night stay | 5-night stay |
| | Domestic destination | International destination |
| | Your choice of a trip that includes | Trip includes a guest, but not |
| | children or not | children |
| | No big name entertainment at | No big name entertainment at |
| | gatherings | gatherings |
| | Choice of small group activities | Leisure time on your own to |
| | or leisure time on your own to | explore |
| | explore | |
| | A total of 50 trip attendees | A total of 2,000 trip attendees |
| | Your choice from among 2 types | 1 type of trip, based on the |
| | of trips selected by your company | destination selected by your |
| | | company |
| | 3 trip dates to choose from | Trip offered on 1 date |
| | Extensive opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 3_11 | Your choice from among 20 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 5-night stay | 7-night stay |
| | Domestic destination | International destination |
| | Your choice of a trip that includes | Trip includes a guest, but not |
| | children or not | children |
| | No big name entertainment at | No big name entertainment at |
| | gatherings | gatherings |
| | Choice of small group activities | Leisure time on your own to |
| | or leisure time on your own to | explore |
| | explore | |
| | A total of 50 trip attendees | A total of 1,000 trip attendees |
| | Your choice from among 2 types | 1 type of trip, based on the |
| | of trips selected by your company | destination selected by your |
| | | company |
| | 4 trip dates to choose from | Trip offered on 1 date |
| | No opportunity for face-to-face | No opportunity for face-to-face |
| | interaction with senior | interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 3_12 | Your choice from among 5 | One destination, selected by your |
| | destinations selected by your | company |
| | company | |
| | Large, luxury hotel | Large, luxury hotel |
| | Some portion of meals/activities | All expenses paid |
| | at your expense | |
| | 7-night stay | 4-night stay |
| | International destination | Domestic destination |
| | Your choice of a trip that includes | Trip includes a guest, but not |
| | children or not | children |
| | No big name entertainment at | No big name entertainment at |
| | gatherings | gatherings |
| | Choice of small group activities | Leisure time on your own to |
| | or leisure time on your own to | explore |
| | explore | |
| | A total of 50 trip attendees | A total of 500 trip attendees |
| | Your choice from among 2 types | 1 type of trip, based on the |
| | of trips selected by your company | destination selected by your |
| | | company |
| | 2 trip dates to choose from | Trip offered on 1 date |
| | Limited opportunity for face-to- | Limited opportunity for face-to- |
| | face interaction with senior | face interaction with senior |
| | management | management |
| | As many people earn the trip as | A pre-set number of top |
| | achieve their pre-set objective | performers earn the trip |
| | First class air travel | Coach class air travel |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 3_13 | Your choice from among 10 | One destination, selected by your |
| | destinations selected by your | company |
| | company | |
| | Large, luxury hotel | Large, luxury hotel |
| | All expenses paid | Some portion of meals/activities |
| | | at your expense |
| | 4-night stay | 5-night stay |
| | Domestic destination | International destination |
| | Trip includes a guest, but not | Trip includes a guest, but not |
| | children | children |
| | No big name entertainment at | Big name entertainment at |
| | gatherings | gatherings |
| | Choice of small group activities | Leisure time on your own to |
| | or leisure time on your own to | explore |
| | explore | |
| | A total of 100 trip attendees | A total of 500 trip attendees |
| | Your choice from among 3 types | 1 type of trip, based on the |
| | of trips selected by your company | destination selected by your |
| | | company |
| | 4 trip dates to choose from | Trip offered on 1 date |
| | No opportunity for face-to-face | Limited opportunity for face-to- |
| | interaction with senior | face interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 12 | Program to earn reward is 3 |
| | months long | months long |
| I would choose | A [ ] | B [ ] |

Which of these reward trips would you work harder to earn?

| | | |
|---|---|---|
| | Trip Program A | Trip Program B |
| 3_14 | Your choice from among 20 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 5-night stay | 7-night stay |
| | Domestic destination | International destination |
| | Trip includes a guest, but not | Trip includes a guest, but not |
| | children | children |
| | No big name entertainment at | Big name entertainment at |
| | gatherings | gatherings |
| | Choice of small group activities | Leisure time on your own to |
| | or leisure time on your own to | explore |
| | explore | |
| | A total of 100 trip attendees | A total of 2,000 trip attendees |
| | Your choice from among 3 types | 1 type of trip, based on the |
| | of trips selected by your company | destination selected by your |
| | | company |
| | 2 trip dates to choose from | Trip offered on 1 date |
| | Limited opportunity for face-to- | No opportunity for face-to-face |
| | face interaction with senior | interaction with senior |
| | management | management |
| | As many people earn the trip as | A pre-set number of top |
| | achieve their pre-set objective | performers earn the trip |
| | First class air travel | Coach class air travel |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 3_15 | Your choice from among 5 | One destination, selected by your |
| | destinations selected by your | company |
| | company | |
| | Large, luxury hotel | Large, luxury hotel |
| | Some portion of meals/activities | All expenses paid |
| | at your expense | |
| | 7-night stay | 4-night stay |
| | International destination | Domestic destination |
| | Trip includes a guest, but not | Trip includes a guest, but not |
| | children | children |
| | No big name entertainment at | Big name entertainment at |
| | gatherings | gatherings |
| | Choice of small group activities | Leisure time on your own to |
| | or leisure time on your own to | explore |
| | explore | |
| | A total of 100 trip attendees | A total of 1,000 trip attendees |
| | Your choice from among 3 types | 1 type of trip, based on the |
| | of trips selected by your company | destination selected by your |
| | | company |
| | 3 trip dates to choose from | Trip offered on 1 date |
| | Extensive opportunity for face-to- | No opportunity for face-to-face |
| | face interaction with senior | interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 3_16 | Your choice from among 10 | One destination, selected by your |
| | destinations selected by your | company |
| | company | |
| | Large, luxury hotel | Large, luxury hotel |
| | All expenses paid | Some portion of meals/activities |
| | | at your expense |
| | 4-night stay | 5-night stay |
| | Domestic destination | International destination |
| | Family trip (able to bring | Trip includes a guest, but not |
| | children) | children |
| | No big name entertainment at | No big name entertainment at |
| | gatherings | gatherings |
| | Leisure time on your own to | Choice of small group activities |
| | explore | or leisure time on your own to |
| | | explore |
| | A total of 150 trip attendees | A total of 1,000 trip attendees |
| | Your choice from among 4 types | 1 type of trip, based on the |
| | of trips selected by your company | destination selected by your |
| | | company |
| | 2 trip dates to choose from | Trip offered on 1 date |
| | Limited opportunity for face-to- | No opportunity for face-to-face |
| | face interaction with senior | interaction with senior |
| | management | management |
| | As many people earn the trip as | A pre-set number of top |
| | achieve their pre-set objective | performers earn the trip |
| | First class air travel | Coach class air travel |
| | Program to earn reward is 3 | Program to earn reward is 6 |
| | months long | months long |
| I would choose | A [ ] | B [ ] |

Which of these reward trips would you work harder to earn?

| | | |
|---|---|---|
| | Trip Program A | Trip Program B |
| 3_17 | Your choice from among 20 | One destination, selected by your |
| | destinations selected by your | company |
| | company | |
| | Small, luxury boutique-type hotel | Large, luxury hotel |
| | All expenses paid | Some portion of meals/activities |
| | | at your expense |
| | 5-night stay | 7-night stay |
| | Domestic destination | International destination |
| | Family trip (able to bring | Trip includes a guest, but not |
| | children) | children |
| | No big name entertainment at | No big name entertainment at |
| | gatherings | gatherings |
| | Leisure time on your own to | Choice of small group activities |
| | explore | or leisure time on your own to |
| | | explore |
| | A total of 150 trip attendees | A total of 500 trip attendees |
| | Your choice from among 4 types | 1 type of trip, based on the |
| | of trips selected by your company | destination selected by your |
| | | company |
| | 3 trip dates to choose from | Trip offered on 1 date |
| | Extensive opportunity for face-to- | Limited opportunity for face-to- |
| | face interaction with senior | face interaction with senior |
| | management | management |
| | A pre-set number of top | As many people earn the trip as |
| | performers earn the trip | achieve their pre-set objective |
| | Coach class air travel | Coach class air travel, with the |
| | | opportunity to earn first class |
| | Program to earn reward is 6 | Program to earn reward is 12 |
| | months long | months long |
| I would choose | A [ ] | B [ ] |

Which of these reward trips would you work harder to earn?

| | | |
|---|---|---|
| | Trip Program A | Trip Program B |
| 3_18 | Your choice from among 5 | One destination, selected by your |
| | destinations selected by your | company |
| | company | |
| | Large, luxury hotel | Large, luxury hotel |
| | Some portion of meals/activities | All expenses paid |
| | at your expense | |
| | 7-night stay | 4-night stay |
| | International destination | Domestic destination |
| | Family trip (able to bring | Trip includes a guest, but not |
| | children) | children |
| | No big name entertainment at | No big name entertainment at |
| | gatherings | gatherings |
| | Leisure time on your own to | Choice of small group activities |
| | explore | or leisure time on your own to |
| | | explore |
| | A total of 150 trip attendees | A total of 2,000 trip attendees |
| | Your choice from among 4 types | 1 type of trip, based on the |
| | of trips selected by your company | destination selected by your |
| | | company |
| | 4 trip dates to choose from | Trip offered on 1 date |
| | No opportunity for face-to-face | No opportunity for face-to-face |
| | interaction with senior | interaction with senior |
| | management | management |
| | A pre-set number of top | As many people earn the trip as |
| | performers earn the trip | achieve their pre-set objective |
| | Coach class air travel, with the | Coach class air travel |
| | opportunity to earn first class | |
| | Program to earn reward is 12 | Program to earn reward is 3 |
| | months long | months long |
| I would choose | A [ ] | B [ ] |

### Appendix C

The following is an example of questions used to create an online survey to collect the subgroup data.

Notes:

Programmer notes are in CAPS.

[New Screen]

2. How many times have you earned company-sponsored travel reward trips in the past 10 years?

PN: ALLOW 2 DIGITS, ALLOW ZERO, IF 2 OR MORE ASK Q5

[New Screen]

3. Think of all the award trips you have ever earned. Did you attend all of them?

Yes→SKIP TO Q5

No

[New Screen]

4. Thinking of the most recent trip you chose not to attend, was it because . . .

The trip was unappealing to me→ASK 4a

The dates of the trip conflicted with other commitments→SKIP TO Q6 IF RESPONSE IN Q2 IS LESS THAN 2, IF MORE THAN 2 ASK Q5

Other→ASK 4b

[New Screen]

4a. IF RESPONDENT SAYS “TRIP WAS UNAPPEALING TO ME” IN Q4 ASK: What about the trip, specifically, was unappealing to you?

[New Screen]

4b. IF RESPONDENT SAYS “OTHER” IN Q4 ASK: Why did you not attend the trip?

[New Screen]

5. IF RESPONSE IN Q2 IS TWO OR MORE, ASK: What was the best trip you ever attended? Please write in the destination of the trip and the year you took it.

5a. Why was that the best trip?

### Appendix D

The following is an example of questions used to create an online survey provided to activity prioritization data to the decision support tool. There are 4 cells of activity questions.

[image]

[image]

[image]

[image]

[image]

[image]

[image]

[image]

[image]

[image]

[image]

[image]

[image]

[image]

[image]

[image]

[image]

[image]

What is claimed is:

1. A method of developing a reward program to motivate participants associated with a program-owner, said method comprising:
defining attributes and values of the reward program;
collecting from the participants preferred values of the attributes of the reward program;
modeling the collected participant preferred values to generate weighted participants preferred values for the attributes of the reward program;
defining a first reward program as a function of the modeled values, said first reward program including at least some of the defined attributes having values corresponding to the collected preferred values;
defining a second reward program as a function of the modeled values, said second reward program including at least some of the defined attributes having values corresponding to the collected preferred values wherein the values of the second reward program are different than the values of the first reward program;
displaying to the program-owner the first and second reward programs;
providing to the program-owner a comparison of the first reward program to the second reward program as a function of the weighted participants preferred values; and
selecting, by the program-owner, of one of the displayed reward programs based on the provided comparison, said selected reward program being implemented by the program-owner and presented to the participants.

2. The method of claim 1 wherein the comparison indicates a preference of the participants of the first reward program relative to the second reward program whereby the participants are more motivated by the reward program with the highest preference.

3. The method of claim 1, said method further comprising:
defining, by the program-owner, a reward program constraint;
selecting, by the program-owner, either the first reward program or the second program based on the provided comparison; and
modifying, by the program-owner, the selected reward program as a function of the defined constraint.

4. The method of claim 1, said method further comprising:
allowing the program-owner to modify the first reward program and providing to the program-owner a comparison of the modified first reward program to the second reward program as a function of the collected program choice information.

5. The method of claim 1, wherein collecting program choice information further comprises:
designing a survey as a choice-based conjoint experiment;
conducting the surveying to gather data through an online web site questionnaire provided to a subset of participants; and
analyzing the data through hierarchical Bayesian multinomial logit.

6. The method of claim 1, wherein the comparison is generated by a conjoint simulation tool which simulates choices among multiple reward program designs.

7. The method of claim 1, wherein the program attributes include at least one of the following: Trip attributes, Attendee attributes, Activity attributes, Merchandise attributes and Program Guideline attributes;
said Trip attributes including at least one of the following: trip length, hotel type, destination type, destination choices, total trip attendees, number of trip types to choose from, choice of trip dates and air travel seating;
said Attendee attributes including at least one of the following: participant group type and type of attendees;
said Activity attributes including at least one of the following: big name entertainment, free time and opportunity to interact with senior management;
said Merchandise attributes including at least one of the following: type of merchandise and merchandise grouping; and
said Program Guideline attributes including at least one of the following: opportunity to earn reward, length of reward program and ability to bank rewards.

8. The method of claim 1, said method further comprising:
defining subgroups of participants;
collecting participant subgroup information, said participant subgroup information identifying subgroups of participants;
providing a comparison of the first reward program to the second reward program as a function of the collected program choice information and the collected participant subgroup information.

9. The method of claim 8, said method further comprising:
defining, by the program-owner, reward program objectives, said objectives include one or more subgroups of participants to be motivated; and
selecting, by the program-owner, one of the reward programs as a function of the provided comparison and the program-owner defined objectives.

10. The method of claim 8, said method further comprising:
allowing the program-owner to select a subgroup of participants and providing to the program-owner a comparison of the first reward program to the second reward program as a function of the collected program choice information and the collected participant subgroup information.

11. The method of claim 8, wherein the participants are segmented into subgroups by at least one of the following: demographics, firmographics and past reward experience;
said demographics including at least one of the following: geographic location, age, gender, ethnicity, marital status, number of children, education and household income;
said firmographics including at least one of the following: job function, level of responsibility and years of service; and
said past reward experience including at least one of the following: persons who earned a reward program in the past, the number of times a person has earned a reward program in the past and by the length of time since a person has last earned a reward program.

12. The method of claim 1, said method further comprising:
defining participant activities;
collecting participant activity information, said participant activity information indicating a preference of the participant to engage in the defined activity;
providing a ranking of the activities as a function of the collected participant activity information.

13. The method of claim 12, wherein the participant activities include at least one of the following: scenic tours, nature tours, historical tours, cultural tours, golf, spa activities, health activities, wellness activities, beach activities, water sport activities, cultural shopping, general shopping, leisure time, sporting events, theme parks, cultural lessons, hunting, fishing, adventure tours, local dining, ecotourism, interaction with popular entertainers, interaction with popular celebrities, concerts, and entertainment award ceremonies.

14. The method of claim 12, wherein the collecting participant activity information further comprises:
designing a surveying as a maximum difference scaling experiment;
conducting the surveying to gather data from a subset of participants; and
analyzing the data through hierarchical Bayesian multinomial logit.

15. A system for developing a reward program to motivate participants associated with a program-owner comprising:
one or more computer-readable media for storing:
a plurality of program attributes, said attributes defining the reward program;
a collection of program choice information from the participants, said program choice information including participant preferred values of the attributes of the reward program;
a processor being configured to execute computer-executable instructions for:
displaying to the program-owner a first reward program and a second reward program, said first and second reward programs including the identified program attributes, said program attributes having values corresponding to the participant preferred values wherein the values of the first reward program are different than the values of the second reward program; and
providing to the program-owner a comparison of the first reward program to the second reward program as a function of the collected program choice information.

16. A method of developing a reward program for a group of participants associated with a program-owner, said method comprising:
defining a set of program attributes, said programs attributes comprising the reward program;
defining a range of values for each of the program attributes, said values being limited by the program-owner;
surveying the group of participants, said survey designed to evaluate the group's preference to values of the program attributes;
analyzing the responses to the survey to define the reward program, wherein the reward program includes the preferred value of the program attributes;
modifying, by the program-owner, of the defined reward program as a function of the program-owner's constraints and goals;
presenting the modified reward program to the group, wherein the reward program is used to motivate the group.

17. A method of developing a reward program to motivate participants associated with a program-owner, said method comprising:
defining attributes of the reward program, said attributes being associated with a corresponding variable, said variable including a range of possible values for each attribute;
collecting program choice information from the participants, said program choice information including participant preferred variables of the attributes of the reward program;
displaying to the program-owner a first reward program and a second reward program, said first and second reward programs including of the identified program attributes, said program attributes having variables corresponding the participant preferred variables wherein the variables of the first reward program are different than the variables of the second reward program;
providing to the program-owner a comparison of the first reward program to the second reward program as a function of the collected program choice information.
